(19) United States
(12) Patent Application Publication
(10) Pub. No.: US 2007/0039857 A1
(43) Pub. Date: Feb. 22, 2007

(54) Filter sponge with replace-indicating function

(76) Inventor: Shih-Hui Liao, Taoyuan County (TW)

Correspondence Address: PYLE & PIONTEK, ROOM 2036, 221 N LASALLE, CHICAGO, IL, 60601, US

(21) Appl. No.: 11/208,157

(22) Filed: Aug. 19, 2005

(51) Int. Cl. B01D 35/00; A01K 63/04

(52) U.S. Cl. 210/85; 210/91; 210/121; 116/281; 119/259; 210/167.21; 210/167.25

(57) ABSTRACT

A filter sponge having a replace-indicating function is mainly used in an aquatic filter to filter aquatic breed water. The filter sponge includes a sponge body (10) centrally defining therein a vertical passage 11. A replace-indicating mechanism (20) is located at a top side of the vertical passage. When the filter sponge is used to filter breed water, the replace-indicating mechanism indicates to the user the state of the filter sponge, by which the user can be aware of whether the filter sponge needs to be replaced.

### BACKGROUND OF THE INVENTION

1. Field of The Invention

The present invention relates generally to a filter sponge with a replace-indicating function, and more particularly to a novel filter sponge which defines a vertical passage and comprises a replace-indicating mechanism located at a top side of the vertical passage to indicate that the filter sponge has been polluted and needs to be replaced.

2. Description of Related Arts

Water filters having filter sponges have been widely used in aquatic breed. One of such water filters typically defines therein a cavity having an entrance. For most of such water filters, the filter sponge locates beneath the entrance of a cavity. Therefore, after breed water enters the water filter, the breed water must penetrate the filter sponge downwardly before it flows back into the aquarium via an exit formed below the filter sponge. By passing the breed water through the filter sponge, the filter sponge can thus filter and clean the breed water.

The simply constructed filter sponge as described above indeed can filter and clean the water. However, because the breed water penetrates the filter sponge from a top side toward a bottom side of the filter sponge, contaminations the filter cleans from the water will be easily accumulated on the top side of the filter sponge. If this accumulation increases greatly, the breed water can hardly penetrate the filter sponge downwardly. As a result, the overall filtering performance of the filter sponge will decrease, even if the bottom section of the filter sponge can still be used. Due to this problem, the filter sponges of this kind as described above are often criticized by their users.

As an attempt to resolve this problem, the filter sponge is proposed to be located above the entrance. To avoid an excursion of the filter sponge away from its original position due to the floatage of the breed water, the filter sponge defines therein a vertical passage acting as a buffering zone to lessen the floatage. Therefore, the breed water flows into the vertical passage from a bottom side of the filter sponge, and further penetrates through the wall portion of the filter sponge, by which the contaminated water is cleaned. For a fresh filter sponge, once the breed water enters the vertical passage, it directly penetrates through a bottommost section of the wall portion of the filter sponge. Therefore, the filter sponge at the bottommost section thereof forms a filtering zone. As this bottommost section of the filter sponge continuously accumulates the contaminations, the breed water moves along the vertical passage to a higher level, which results in an upward movement of the filtering zone for further filtering operation. Thus, this kind of filter sponge has an improved filtering performance and lifetime.

However, the filter sponge is generally arranged in a closed filter. If the user fails to timely check the filter sponge, it may often happen that, the filter sponge has also been completely polluted and lost its filtering function but the user has not been aware of that. Thus, the overall filtering performance of the filter sponge will decrease. What is needed, therefore, is to provide a filter sponge that the user can easily and effectively check whether it can still be used to filter water or not.

### SUMMARY OF THE INVENTION

A primary object of the present invention is to provide a filter sponge having a replace-indicating function which comprises a sponge body defining therein a vertical passage, and a replace-indicating mechanism located at a top side of the vertical passage. The replace-indicating mechanism has an indicator to achieve an indication function in a floating manner by which the user can be indicated that the sponge body needs to be replaced.

A secondary object of the present invention is to provide a filter sponge having a replace-indicating function which comprises a sponge body defining therein a vertical passage, and a replace-indicating mechanism located at a top side of the vertical passage. The replace-indicating mechanism has a cover to achieve an indication function in a pivoting manner by which the user can be indicated that the sponge body needs to be replaced.

### BRIEF DESCRIPTION OF THE DRAWINGS

FIG. 1 is an isometric, exploded view of a filter sponge having a replace-indicating function in accordance with embodiments of the present invention;

FIG. 2 is a schematic view showing an initial use state of the filter sponge of FIG. 1 assembled to a filter according to a first embodiment;

FIG. 3 is a schematic view showing a state of the filter sponge of FIG. 1 that needs to be replaced according to the first embodiment;

FIG. 4 is a schematic view showing an initial use state of the filter sponge of FIG. 1 assembled to a filter according to a second embodiment; and

FIG. 5 is a schematic view showing a state of the filter sponge of FIG. 1 that needs to be replaced according to the second embodiment.

### DESCRIPTION OF PREFERRED EMBODIMENTS

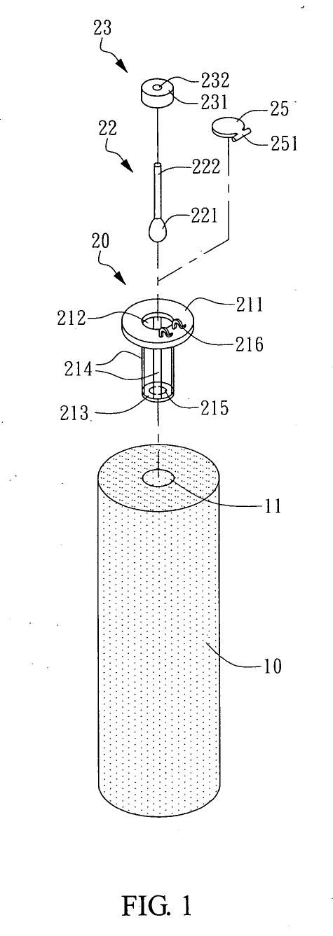

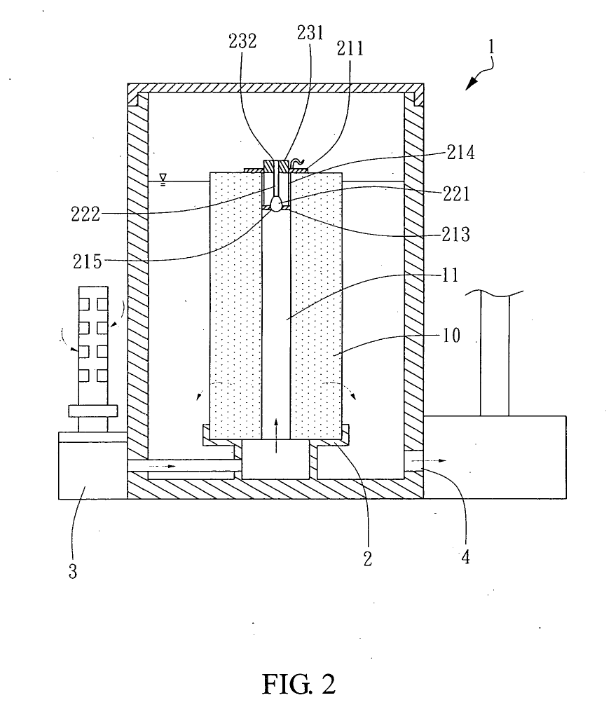

Referring to FIG. 1, a filter sponge of the present invention is used in an aquatic filter 1 (FIG. 2 through 5) to filter aquatic breed water. The filter sponge in accordance with a first embodiment of the present invention comprises a sponge body 10 and a replace-indicating mechanism 20. The sponge body 10 is configured to be in a form of a column, and centrally defines therethrough a vertical passage 11.

The replace-indicating mechanism 20 comprises a base member 21, a buoy 22 and a buoy positioning member 23. The base member 21 comprises a horizontal top portion 211 for being placed on a top side of the sponge body 10. The horizontal top portion 211 defines a thought hole 212 aligned with the vertical passage 11. A plurality of connecting stripes 214 extends downwardly along an inner wall of the sponge body 10. Spaces (not labeled) are formed between two adjacent connecting stripes 214. A horizontal bottom portion 213 connects free bottom ends of the connecting stripes 214. A though opening 215 is centrally defined in the horizontal bottom portion 213.

The buoy 22 comprises a suspending body 221 which can sit on the horizontal bottom portion 213 at the through opening 215 thereof, and an indicator 222 extending upwardly from the suspending body 221. The indicator 222 has such a weight as to balance the floatage of the breed water; so that the floatage of the breed water will not move the buoy 22 upwardly when the buoy 22 is disposed in the filter 1.

The buoy positioning member 23 comprises a horizontal plate 231 which can be positioned at the through hole 212 of the horizontal top portion 211. The horizontal plate 231 defines a through aperture 232 for allowing the indicator 222 to vertically move therein.

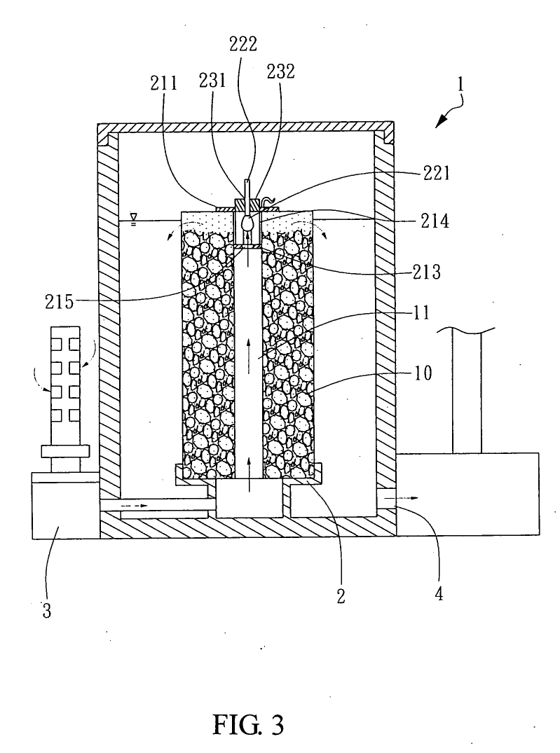

Referring to FIGS. 2 and 3, the filter 1 comprises a support base 2 for supporting and positioning the filter sponge 10. When the filter sponge is assembled to the support base 2, the level of the internal water of the filter is set to be lower than a topmost position of the filter sponge. Since the weight of the indicator 222 is designed so as to balance the floatage of the water, the suspending body 221 can still sit on the horizontal bottom portion 213 as illustrated in FIG. 2.

In use, the breed water in an aquarium (not shown) is pumped into the filter 1 by a pump 3 located in the aquarium. The breed water level rises along the vertical passage 11 of the sponge body 10. In FIG. 2, the sponge body 10 is a fresh one. That is, pores of sponge body 10 have not been obstructed by the contaminations of the breed water. Therefore, once the breed water enters the vertical passage 11, it directly penetrates through a bottom section of the wall portion of the sponge body 10, by which the breed water is filtered and cleaned. Then, the cleaned water flows back into the aquarium via an exit 4 of the filter 1.

It should be understood that, in initial use, the filtering zone of the filter sponge locates at the bottom section of the sponge body 10. Therefore, the contaminations in the breed water are only accumulated at the bottom section of the sponge body 10 in the initial use. However, as the using time goes, the bottom section of the sponge body 10 gradually loses its filtering function because the contaminations are continuously accumulated thereat. The breed water then moves upwardly along the vertical passage 11 to a higher level, which results in an upward movement of the filtering zone. When the filtering zone moves to the topmost section of the sponge body 10 as illustrated in FIG. 3, the upwardly moving breed water pushes the suspending body 221 to move upwardly. The upwardly moving breed water then passes spaces between the adjacent connecting stripes 214 and penetrates through the sponge body 10, by which the breed water is filtered and cleaned. In addition, since the suspending body 221 is pushed to move upwardly, the indicator 222 on the suspending body 221 is pushed to move upwardly and extend through the through aperture 232 of the horizontal plate 231. When the user sees the indicator 222 extending beyond the horizontal plate 231, the user can realize that the filter sponge needs to be replaced. In this way, the filter sponge of the first embodiment can perform an indication of replacing the filter sponge to the user

Referring back to FIG. 1, in a filter sponge in accordance with a second embodiment of the present invention, the indicator 22 and the buoy positioning member 23 of the first embodiment may be omitted. Instead, a cover 25 is pivotably attached to the horizontal top portion 211 with a pivot structure. The cover 25 coves the through hole 212 of the horizontal top portion 211 in a closed position wherein the through hole 212 is closed at a top side thereof. The cover 25 forms a set of axles 251 at one side thereof. The horizontal top portion 211 further forms a cover holder 216 pivotably receiving the axles 251 of the cover 25 therein to constitute the pivot structure. Therefore, the cover 25 is able to pivot with respect to the cover holder 216 upwardly to an open position wherein the top side of the through hole 212 is open.

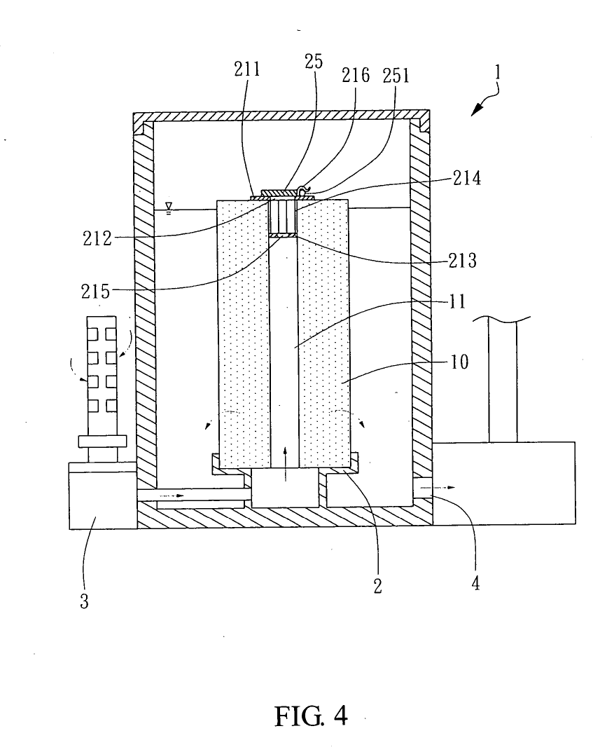

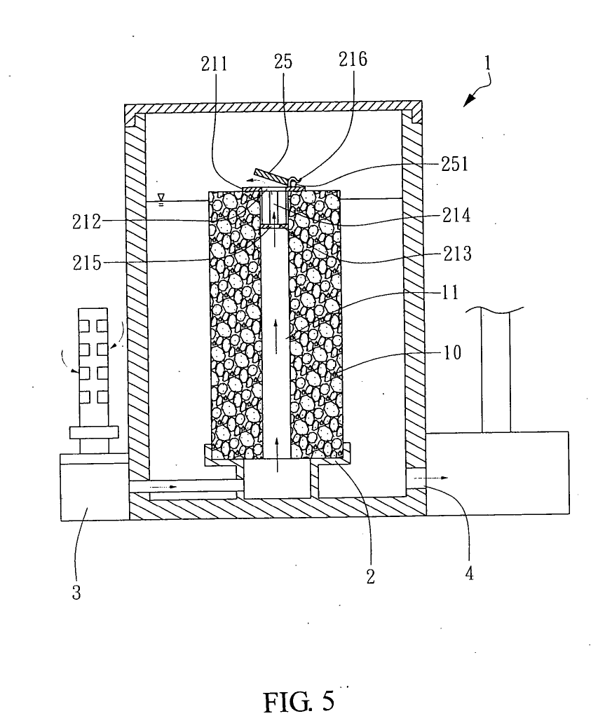

Referring to FIGS. 4 and 5, the filter sponge of the second embodiment is also assembled to the support base 2, with the level of the internal water of the filter 1 being lower than a topmost position of the filter sponge. Since the cover 25 locates above the internal water level, the cover 25 completely covers the through hole 212 of the horizontal top portion 211 as illustrated in FIG. 4.

As described above, the sponge body 10 is a fresh one. Therefore, once the breed water enters the vertical passage 11, it directly penetrates through a bottom section of the wall portion of the sponge body 10, by which the breed water is filtered and cleaned. Then, the cleaned water flows back into the aquarium via the exit 4 of the filter 1. That means, in initial use, the filtering zone of the filter sponge mainly locates at the bottom section of the sponge body 10. Therefore, the contaminations in the breed water are only accumulated at the bottom section of the sponge body 10 in the initial use.

However, as the using time goes, the bottom section of the sponge body 10 gradually loses its filtering function because the contaminations are continuously accumulated thereat. The breed water then moves upwardly along the vertical passage 11 to a higher level, which results in an upward movement of the filtering zone. When the filtering zone moves to the topmost section of the sponge body 10 as illustrated in FIG. 5, the upwardly moving breed water passes spaces between adjacent connecting stripes 214 and penetrates through the sponge body 10, by which the breed water is filtered and cleaned. When the sponge body 10 is completely obstructed by the accumulated contaminations, the breed water moves further upwardly through the through hole 212 of the horizontal top portion 211. As a result, the cover 25 is pivoted upwardly by the upwardly moving breed water into the open position as illustrated in FIG. 5. When the user sees the cover 25 in the open position, the user can realize that the filter sponge needs to be replaced. In this way, the filter sponge of the second embodiment can perform an indication of replacing the filter sponge to the user.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

We claim:

1. A filter sponge having a replace-indicating function for use in an aquatic filter to filter breed water, the filter sponge comprising:
a sponge body being configured to be in a form of a column, and centrally defining therethrough a vertical passage; and
a replace-indicating mechanism, comprising;
a base member, comprising a horizontal top portion for being placed on the sponge body, the horizontal defining a through hole aligned with the vertical passage, a plurality of connecting stripes extending downwardly along an inner wall of the sponge body, a horizontal bottom portion connecting free bottom ends of the connecting stripes, a though opening being centrally defined in the horizontal bottom portion;
a buoy, comprising a suspending body which can sit on the horizontal bottom portion at the through opening thereof, and an indicator extending upwardly from the suspending body; and
a buoy positioning member, comprising a horizontal plate which can be positioned at the through hole of the horizontal top portion, the horizontal plate defining a through aperture for allowing the indicator to vertically move therein.

2. A filter sponge having a replace-indicating function for use in an aquatic filter to filter breed water, the filter sponge comprising:
a sponge body being configured to be in a form of a column, and centrally defining therethrough a vertical passage; and
a replace-indicating mechanism, comprising;
a base member, comprising a horizontal top portion for being placed on the sponge body, the horizontal defining a through hole aligned with the vertical passage, a plurality of connecting stripes extending downwardly along an inner wall of the sponge body, a horizontal bottom portion connecting free bottom ends of the connecting stripes, a though opening being centrally defined in the horizontal bottom portion; and
a cover covering the through hole of the horizontal top portion and being pivotable to open the through hole with a pivot structure.

3. The filter sponge having a replace-indicating function of claim 2, wherein the pivot structure comprises an axle formed on one side of the cover, and a cover holder formed on the horizontal top portion to pivotably receiving the axle therein.
